(19) United States
(12) Patent Application Publication
(10) Pub. No.: US 2007/0141217 A1
(43) Pub. Date: Jun. 21, 2007

(54) High intensity sweeteners and coloring agent compositions

(76) Inventors: Shane Riley Benedict, Hackettstown, NJ (US); Scott Martling, Ithaca, NY (US); Catalin Moraru, Ithaca, NY (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/225,736

(22) Filed: Dec. 19, 2005

(51) Int. Cl. A23L 1/27

(52) U.S. Cl. 426/540

(57) ABSTRACT

Compositions including a high intensity sweetener and a coloring agent are provided. More particularly, compositions that provide sweetness and a burst of color when added to a foodstuff are provided. Also provided are methods of making such compositions and methods of sweetening and coloring a foodstuff using such compositions.

### FIELD OF THE INVENTION

The present invention relates to compositions containing a high intensity sweetener and a coloring agent. More particularly, the present invention relates to compositions that provide sweetness and a burst of color when added to a foodstuff. The present invention also relates to methods of making such compositions and to methods for preparing a foodstuff containing such compositions.

### BACKGROUND OF THE INVENTION

People often customize the taste of food and beverages by adding sweeteners thereto. For example, sweeteners are added to beverages, such as, coffee and tea; on cereals; on fruit; as toppings on baked goods; and in many other ways. Sweetening a food or beverage alters its flavor and usually increases its appeal. This behavior is found in all cultures, but is especially prevalent in western cultures.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from many sources, e.g., sugar cane and sugar beet roots.

Sugar alcohols are another form of sweetener. Sugar alcohols are derived from sugar molecules, but are classified as alcohols. Sugar alcohols vary in sweetness from half as sweet to about as sweet as sucrose. Accordingly, sugar alcohols may be used in place of sugar. Sugar alcohols have about one-half to three-quarters the amount of calories of sugar, on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, sucrose, are not absorbed when ingested and are therefore non-nutritive sweeteners.

People also customize the appearance of food and beverages to suit their preferences. One way to achieve such customization is to change the color of or to add color to the food or beverage. This modification of the color of a food or beverage may make the food or beverage more palatable or appetizing, e.g., making a gravy a deep brown color, or may make the food or beverage more fun or festive, e.g., making a green iced tea for St. Patrick's day or a pink cake for Valentine's day.

Food coloring is of particular importance to children. Making foods or beverages fun and appetizing can make the difference between a pleasant and a frustrating dining experience when children are involved. To that end, foods and beverages designed for children are often vibrantly, and sometimes oddly, colored. For example, red, green, purple, pink, orange, blue, and teal-colored ketchup has been available to consumers. Children's cereals also are available in every color of the rainbow and some of them, when contacted with milk, are designed to release color into the milk.

Moreover, children often enjoy helping to prepare foods or beverages. However, their attention may wane or be lost during the preparation. Thus, the addition of color, and color bursts, during the food or beverage preparation process provides an easy and fun way to keep a child's attention.

Accordingly, it would be advantageous to provide a single composition that delivers both sweetness and color to a food or beverage. In particular, it would be advantageous to provide a composition that provides low-calorie sweetness and color to food and beverages. Also advantageous are compositions that provide sweetness and a burst of color to a food or beverage during preparation.

### SUMMARY OF THE INVENTION

One embodiment of the invention is a composition that comprises, consists of and/or consists essentially of a high intensity sweetener and a coloring agent.

Another embodiment of the invention is a composition that comprises, consists of and/or consists essentially of sucrose and a coloring agent. In this embodiment, the coloring agent is selected from FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

Another embodiment of the invention is a foodstuff that comprises, consists of and/or consists essentially of a composition that includes a high intensity sweetener and a coloring agent.

A further embodiment of the invention is a method of making a composition for sweetening and coloring a foodstuff. The method comprises, consists of and/or consists essentially of combining a high intensity sweetener with a coloring agent.

Another embodiment of the invention is method for sweetening and coloring a foodstuff. This method comprises, consists of and/or consists essentially of combining a foodstuff with a composition that comprises, consists of and/or consists essentially of a high intensity sweetener and a coloring agent.

### BRIEF DESCRIPTION OF THE DRAWINGS

FIG. 1 shows the dose response of hydrated sucrose and FD&C Red No. 40 or Blue No. 1 compositions for the Hunter Color “L” value.

FIG. 2 shows the dose response of hydrated sucrose and FD&C Red No. 40 or Blue No. 1 compositions for the Hunter Color “a” value.

FIG. 3 shows the dose response of hydrated sucrose and FD&C Red No. 40 or Blue No. 1 compositions for the Hunter Color “b” value.

### DETAILED DESCRIPTION OF THE INVENTION

The present invention relates to subject disclosed in U.S. application Ser. No. ______, entitled “SWEETENER AND AROMA COMPOSITIONS”, and U.S. application Ser. No. ______, entitled “A SELF-MIXING TABLETOP SWEETENER,” which were both filed on Sep. 13, 2005, and are hereby incorporated by reference as if recited in full herein.

One embodiment of the invention is a composition that contains a high intensity sweetener and a coloring agent.

As used herein, unless otherwise indicated, the term “high intensity sweetener” means a substance that provides a high sweetness per unit mass as compared to a nutritive sweetener and provides little or no nutritive value. Many high intensity sweeteners are known to those skilled in the art and any may be used in the present invention. High intensity sweeteners useful in the present invention include, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucrose (SPLENDA® Brand No Calorie Sweetener, McNeil Nutritionals, LLC) stevia, thaumatin, salts, derivatives, and combinations thereof. A preferred sweetener according to the present invention is sucrose.

As used herein, unless otherwise indicated, the term “sugar alcohol” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, unless otherwise indicated, the term “coloring agent” means any substance that may be employed to produce a desired color, for example, in a food or beverage. Such coloring agents are approved for human consumption pursuant an appropriate governmental agency and/or act, such as the Food and Drug Administration (FDA)/Federal Food Drug and Cosmetic Act (FD&C) in the US or an analogous agency of the European Union. For example, the coloring agent may be a food-grade dye or a lake. In the present invention, a “dye” is a water soluble compound, which is available as a powder, granule, liquid or other special purpose form. Dyes are typically used in beverages, dry mixes, baked goods, confections, dairy products, pet foods, and a variety of other products. A “lake” is a water insoluble form of a dye. Typically, lakes are more stable than dyes and are ideal for coloring products containing fats and oils or items lacking sufficient moisture to dissolve dyes. Lakes are typically used in coated tablets, cake and donut mixes, hard candies, and chewing gums.

Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice, beet powder, beta-carotene, beta-apo-8-carotenal, black currant, burnt sugar, canthaxanthin, caramel, carbo medicinalis, carmine, carmine/beta-carotene, carmine blue, carminic acid, carrot, carrot oils, chlorophyll, chlorophyllin, cochineal extract, copper-chlorophyll, copper-chlorophyllin, curcumin, curcumin/Cu-chlorophyllin, elderberry, grape, grape skin extracts, hibiscus, lutein, mixed carotenoids, paprika, paprika extract, paprika oleoresin, riboflavin, saffron, spinach, stinging nettle, titanium dioxide, turmeric, and combinations thereof. Preferred coloring agents according to the present invention are FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

A preferred composition according to the present invention may contain a high intensity sweetener, such as for example, sucrose and a coloring agent selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

The compositions of the present invention may contain at least one additional coloring agent, such as for example 2, 3, 4, 5, 6, 7, 8, 9, or 10 or more different coloring agents.

In an embodiment of the present invention, the composition contains sucrose and two coloring agents that produce a primary color, e.g., red, yellow, or blue. These compositions produce one of the three secondary colors, orange, green, or purple, when mixed with a foodstuff. Preferably, the first coloring agent is unencapsulated and the second coloring agent is encapsulated in a water-reactive encapsulating agent. Upon mixing the first coloring agent immediately provides a primary color to the foodstuff. Then, after a delay caused by the dissolution of the water-reactive encapsulating agent the second coloring agent is released the color of the foodstuff changes to a secondary color. For example, in a composition where the first coloring agent is a red dye and the second coloring agent is a yellow dye, upon mixing with the composition, the foodstuff will immediately turn red and after a delay will change to orange. The appropriate primary colors required to produce a desired secondary color are well know in the art.

The coloring agent(s) may be present in any amount in the composition. Preferably, the coloring agent is present in an amount from about 0.01% to about 10% weight based on the total weight of the composition. More preferably, the coloring agent is present in an amount from about 0.05% to about 1% weight based on the total weight. of the composition. Even more preferably, the coloring agent is present in an amount of from about 0.1 to about 0.5% weight based on the total weight of the composition.

As used herein, all numerical ranges provided are intended to expressly include at least the endpoints and all numbers that fall between the endpoints of ranges.

As used herein, unless otherwise indicated, the term “foodstuff” means any edible substance to which a coloring agent and/or a high intensity sweetener may be added. Foodstuffs useful in the present invention include, for example, cereals, cakes, cookies, muffins, breads, quick breads, yogurts, fruits, vegetables, ice creams, frozen yogurts, frozen custards, fruit fillings, icings, frostings, gelatins, puddings, cheeses, and beverages, e.g., coffee, tea, milk, and seltzer.

The compositions of the present invention may be in any form commonly used to color a foodstuff. Composition forms useful in the present invention include, for example, liquids, granules, tablets, powders, crystals, and cubes.

Compositions of the present invention may also be integrated with a device suitable for contacting with a foodstuff, such as, a beverage or a slurry. Preferably, the device is used for mixing a beverage. Exemplary devices include a swizzle sticks, stirrers, and straws. With respect to this embodiment, “integrated” means that the composition of the present invention is temporarily housed within, disposed on a surface of, or otherwise intimately in contact with the device. Upon placing the device into contact with a foodstuff, e.g., a beverage, a composition of the present invention is released from the device and dissolves into the foodstuff, thereby imparting sweetness and color to the foodstuff.

Compositions of the present invention may also be incorporated into a breath strip or mint. In the present invention, “breath strip” means a thin water-soluble sheet that disintegrates upon contact with water and imparts a desired scent to the breath of an individual using it. As used herein, “mint” means any solid composition, not in the form of a sheet, that imparts a desired scent to the breath of an individual using it. When used in a breath strip or mint, the composition provides a sweet flavor and colors the tongue when dissolved in the mouth of the user.

In the present invention, the high intensity sweetener and the coloring agent may be present in the composition in various forms. For example, the high intensity sweetener and the coloring agent may be present in the composition in crystalline or granular form.

In the present invention, a foodstuff may be engineered to achieve interesting organoleptic, e.g., taste and color, properties based on the design of the compositions described herein. Non-limiting variables that may be used in the design of the compositions of the present invention include whether to encapsulate the high intensity sweeter or the coloring agent(s) or both, the selection of encapsulation technique, the selection of encapsulation material, and the number of coloring agents used. Table 1 below exemplifies some of the organoleptic characteristics that may be engineered into foodstuffs based on how the compositions of the present invention are designed.

For example, in one composition, the coloring agent may be enrobed in the high intensity sweetener itself, or in a composition containing the high intensity sweetener, such that the coloring agent is not visible in the composition. In another composition, the high intensity sweetener may be encased by a shell that includes an encapsulating agent and the coloring agent. In yet another composition, both the coloring agent and the high intensity sweetener may be encased in a shell. In a further embodiment, one or more coloring agents are encapsulated with the same or different encapsulating agents, combined with a high intensity sweetener, and the high intensity sweetener and encapsulated coloring agent(s) are further encased in a shell. The exact design of the present compositions will be determined based on the desired organoleptic properties of the foodstuff.

As used herein, unless otherwise indicated, the term “encapsulating agent” means a food-grade material that surrounds and isolates one or more actives, e.g., the high intensity sweetener and/or the coloring agent, from the surrounding environment. A “food-grade material” for purposes of the present invention is a material that is safe for use in a food or beverage that will be consumed by a human (or animal). Standards for determining whether materials are safe for human consumption are set forth in the Codex Alimentarius produced by the World Health Organization (1999), which is incorporated by reference herein as if recited in full.

In the present invention, the encapsulating agent has an additional property that allows it to release the encapsulated active when exposed to certain predefined conditions. For example, encapsulating agents useful in the present invention include, water-reactive encapsulating agents, heat-reactive encapsulating agents, pH-reactive encapsulating agents, and enzyme-reactive encapsulating agents. In the present invention, such encapsulating agents may be used alone or in different combinations to achieve different organoleptic effects.

As used herein, unless otherwise indicated, the term “water-reactive encapsulating agents” include those food-grade materials that may be used to surround and isolate one or more actives and that when contacted with water release the encapsulated active. Non-limiting examples of water-reactive encapsulating agents useful in the present invention include food-grade starches, gelatins, pectins, sugars, maltodextrins, and sugar alcohols.

As used herein, unless otherwise indicated, the term “heat-reactive encapsulating agents” include those food-grade materials that may be used to surround and isolate one or more actives and that when exposed to an environment with a predetermined temperature release the encapsulated active. Non-limiting examples of heat-reactive encapsulating agents useful in the present invention include food-grade lipids, fats, pectins, sugars, starches, and sugar alcohols.

As used herein, unless otherwise indicated, the term “pH-reactive encapsulating agents” include those food-grade materials that may be used to surround and isolate one or more actives and that when contacted with a foodstuff having a certain pH, release the encapsulated active.

As used herein, unless otherwise indicated, the term “enzyme-reactive encapsulating agents” include those food-grade materials that may be used to surround and isolate one or more actives and that when brought into contact with an environment containing an enzyme release the encapsulated active.

As noted above, in addition to the choice of encapsulating material used to encapsulate the active(s), e.g., high intensity sweetener(s) and/or coloring agent(s), the selection of encapsulation technique also affects, e.g., the sweetness and/or color characteristics of a foodstuff. For example, one or more actives may be macro-encapsulated or micro-encapsulated in an encapsulating agent. As used herein, “macro-encapsulated” means the particles are larger than about 10 microns and encapsulated in an encapsulating agent. When a macro-encapsulated active, e.g., coloring agent, is released from the encapsulating agent it produces a large, localized burst of color in a beverage, e.g., iced tea, or a large, localized area of color in dry or semidry foodstuff, e.g., a cake.

As used herein, unless otherwise indicated, the term “micro-encapsulated” means the particles are smaller than or equal to about 10 microns and encapsulated in an encapsulating agent. When a micro-encapsulated active, e.g., coloring agent, is released from the encapsulating agent it produces a diffuse burst of color throughout the foodstuff.

The process of macro- and micro-encapsulation are identical with exception with only the size of the particles produced differing. The actives, e.g., high intensity sweetener(s) and/or coloring agent(s) may be encapsulated using any method known in the art. Encapsulation methods useful in the present invention include, for example, fluidized bed coating, pan coating, agglomeration, coglomeration, and spray drying.

The compositions of the present invention may optionally include one or more food-grade additives. The food-grade additives are combined with the high intensity sweetener and/or the coloring agent and/or the encapsulating agent using conventional methods, such as for example mixing or blending. Food-grade additives useful in the present invention include, for example, carbonation systems, flavors, texture enhancers, aromas, bulking agents, and combinations thereof. Preferably, the additive is a carbonation system.

As used herein, unless otherwise indicated, the term “carbonation system” means any food-grade composition or mixture that releases a non-toxic gas, such as for example, carbon dioxide, when added to a beverage or ingestible liquid. Generally, carbonation systems include a solid form of an organic, food-grade acid and a form of carbonate. Organic, food-grade acids useful in the present invention include, for example, citric acid, malic acid, succinic acid, butyric acid, and combinations thereof. Carbonate forms useful in the present invention include, for example, sodium bicarbonate, potassium bicarbonate, calcium bicarbonate, and combinations thereof. Preferably, the carbonation system includes sodium bicarbonate and a mixture of citric acid and malic acid.

When such a composition is mixed with, e.g., a beverage, the composition begins releasing carbon dioxide, causing the composition (e.g., in tablet or cube form) to float to the top and agitate the liquid (e.g., fizzing). This both increases the speed of dissolution and dispersion of the sweetener and coloring agent. In this manner, an exciting burst of color is seen while producing a mildly carbonated, acidic, sweetened beverage.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “texture enhancer” means any substance that may be employed to produce a desired texture. Texture enhancers useful in the present invention include, for example, guar gum, alginate and salts thereof, taro gum, gellan gum, xanthium gum, amalose, amalopectin, konjac, and combinations thereof.

As used herein, unless otherwise indicated, the term, “aroma” means any substance that may be employed to produce a desired odor, for example, when mixed with a foodstuff. Aromas useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone (juniper, common sage, Nootka cypress, and wormwood), thymol (camphor-like), trimethylamine (fish), vanillin (vanilla), and combinations thereof. Preferred aromas according to the present invention are essential oils (citrus oil), expressed oils (orange oil), distilled oils (rose oil), extracts (fruits), benzaldehyde, d-limonene, furfural, menthol, methyl butanoate, pentyl butanoate, and combinations thereof.

As used herein, unless otherwise indicated, the term “bulking agent” means any substance that may be employed to increase the bulk of the composition without significantly increasing the calories contained in or the sweetness delivered by the composition. Bulking agents are useful in increasing the volume of a high intensity sweetener composition to increase the ease of use for the consumer, e.g., in accurately adding sweetness to a beverage. Bulking agents useful in the present invention include, for example, maltodextrin, fructo-ogliosaccharide, polydextrose, inulin, fibersol, derivatives, and combinations thereof.

The compositions of the present invention may be delivered in any packaged form typically used for delivering a sweetener. Generally, the composition may be packaged for industrial or commercial use, such as in the food services industry, or for use by consumers in the same manner as sugar. These packaged forms may include, for example, boxes, bags, envelopes, pouches, drums, tubs, and the like, and individual use (i.e., unit package) forms, such as packets.

Moreover, the compositions of the present invention may be incorporated into premixed food or beverage preparations in the same manner as other sweeteners. Food preparations may include, for example, cookie or cake mix, cookie dough, and beverage mixes. Preparations of this type will provide the same convenience as those containing other sweeteners, but have the advantage of delivering color to the finished product.

Thus, another embodiment of the invention is a foodstuff that includes one of the compositions described above. The foodstuff may be a liquid, e.g., a beverage, or a solid formulation.

Another embodiment of the present invention is a method of making a composition for sweetening and coloring a foodstuff. This method includes combining a high intensity sweetener and a coloring agent. Preferably, the method includes combining sucrose and a coloring agent selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

In accordance with the present method, the ingredients of the composition may be combined by any means known in the art to combine dry components. Preferably, the components are mixed or blended.

In this method, the coloring agent may be macro-encapsulated or micro-encapsulated in an encapsulating agent prior to combination with the high intensity sweetener. For example, the coloring agent may be micro-encapsulated to form a free-flowing powder. The micro-encapsulated coloring agent may then be combined with a crystalline form of the high intensity sweetener to form a homogenous, dry, granular form of the composition.

As described above, one or more additional coloring agents may be incorporated into the present compositions using conventional methods for combining dry ingredients. Each of the coloring agents in the composition may be encapsulated or not as described above and as exemplified, e.g., in Table 1. Moreover, each coloring agent may be incorporated into the same or a different type of encapsulating agent, using the same or a different type of encapsulating process (e.g., micro- or macro-encapsulation), depending on the intended color effect to be achieved.

TABLE 1
Exemplary compositions of the present invention and their effects upon mixing with a foodstuff.

| EXEMPLARY COMPOSITIONS | | | | | | | |
|---|---|---|---|---|---|---|---|
| Coloring Agent 1 | | Coloring Agent 2 | | Sweetener | | Food | |
| Encapsulation | Type | Encapsulation | Type | Encapsulation | Type | Stuff | Result upon Mixing |
| None | — | Micro | Heat | None | — | Clear | Immediate sweetening and color 1 followed by color |
| | | | | | | Drink | change to combination of color 1 and color 2 upon |
| | | | | | | | heating of drink. |
| | | | | | | Cake | Immediate sweetening and color 1 followed by color |
| | | | | | | | change to combination of color 1 and color 2 upon |
| | | | | | | | baking of cake. |
| Micro | Water | Micro | Heat | None | — | Clear | Immediate sweetening followed by color 1 upon |
| | | | | | | Drink | dissolution of water-reactive encapsulating agent and |
| | | | | | | | color change to combination of color 1 and color 2 |
| | | | | | | | upon heating of drink. |
| | | | | | | Cake | Immediate sweetening followed by color 1 upon |
| | | | | | | | dissolution of water-reactive encapsulating agent in |
| | | | | | | | batter and color change to combination of color 1 |
| | | | | | | | and color 2 upon baking of cake. |
| Macro | Heat | Macro | Heat | None | — | Clear | Immediate sweetening of drink. Production of a |
| | | | | | | Drink | combination of colors 1 and 2 upon heating of drink. |
| | | | | | | Cake | Immediate sweetening of batter. Production of tie |
| | | | | | | | dyed pattern of colors 1 and 2 upon baking of cake. |
| Micro | Water | Macro | Heat | None | — | Clear | Immediate sweetening and color 1 followed by color |
| | | | | | | Drink | change to combination of color 1 and color 2 upon |
| | | | | | | | heating of drink. |
| | | | | | | Cake | Immediate sweetening and color 1 of batter. |
| | | | | | | | Production of spots of color 2 upon baking of cake. |

In this method, the coloring agent may be enrobed by the high intensity sweetener itself, or by a composition that includes the high intensity sweetener, such that the coloring agent is not visible. The composition may be formed in any manner known in the art. For example, the desired quantity of coloring agent may be enrobed in an encapsulating agent and the desired amount of sweetener may then be deposited on the exposed surface of the encapsulating agent by any means known in the art, e.g., spraying.

Alternatively, the high intensity sweetener may be surrounded by a shell that includes an encapsulating agent and the coloring agent. This composition may also be formed in any manner known in the art. For example, the desired quantity of high intensity sweetener may be compressed into a tablet or spherical form. The encapsulating agent and coloring agent may be combined to form a solution or slurry containing a sufficient concentration of coloring agent to obtain the desired effect. The encapsulating agent/coloring agent solution or slurry may then be deposited on the surface of the high intensity sweetener by any means known in the art, e.g., spraying.

Another embodiment of the present invention is a method of preparing a foodstuff. This method includes combining a foodstuff with a composition of the present invention. Preferably, this method is accomplished by combining a foodstuff and a composition of the present invention including sucrose and a coloring agent selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

In the methods of the present invention, the respective combining steps may be accomplished using any conventional process, e.g., blending, hand-mixing, shaking, stirring, and sprinkling over the foodstuff. In general, the methods and compositions of the present invention work as follows. Upon mixing a composition of the present invention with a foodstuff:
any free sweetener and free coloring agent immediately impart sweetness and color, respectively, to the foodstuff;
any sweetener or coloring agent encapsulated in a water-reactive encapsulating agent is released to impart sweetness or color, respectively, to the foodstuff upon dissolution or otherwise breakdown of the encapsulating agent;
any sweetener or coloring agent encapsulated in a heat-reactive encapsulating agent is released to impart sweetness or color, respectively, to the foodstuff upon heating the foodstuff to the temperature required to melt or otherwise breakdown the encapsulating agent;
any sweetener or coloring agent encapsulated in a pH-reactive encapsulating agent is released to impart sweetness or color, respectively, to the foodstuff upon reaching the pH required to breach the encapsulating agent;
any sweetener or coloring agent encapsulated in an enzyme-reactive encapsulating agent is released to impart sweetness or color, respectively, to the foodstuff upon addition of the enzyme required to breach the encapsulating agent.
   The release of the active(s), e.g., coloring agent(s) by breach of one or more encapsulating agent(s) may result in a burst of color and/or an overall change of color in a foodstuff, e.g., in a beverage, or in localized change of color, e.g., in a cookie with heat-reactive, macro-encapsulation.

The following examples are provided to further illustrate the compositions and methods of the present invention. These examples are illustrative only and are not intended to limit the scope of the invention in any way.

### EXAMPLES

### Example 1

Compositions of the present invention with the amounts of SPLENDA® Brand No Calorie Sweetener and coloring agent shown in Table 2 are prepared in two quart mason jars by mixing for 5 minutes at 32 rpm using a Turbula T2F dry powders mixer (WAB AG, Basel, Switzerland).

TABLE 2
SPLENDA ® Brand No Calorie Sweetener and
FD&C Red No. 40 or FD&C Blue No. 1 compositions.

Weight (g)

| | | | SPLENDA ® |
|---|---|---|---|
| | | | Brand No |
| Coloring | | | Calorie |
| Agent | Weight (%) | Coloring Agent | Sweetener |
| Red No. 40 | 0.1 | 0.1 | 99.9 |
| | 0.3 | 0.3 | 99.7 |
| | 0.5 | 0.5 | 99.5 |
| | 0.7 | 0.7 | 99.3 |
| | 0.9 | 0.9 | 99.1 |
| Blue No. 1 | 0.02 | 0.02 | 99.98 |
| | 0.04 | 0.04 | 99.96 |
| | 0.06 | 0.06 | 99.94 |
| | 0.08 | 0.08 | 99.92 |
| | 0.1 | 0.1 | 99.9 |
| | 0.3 | 0.3 | 99.7 |
| | 0.5 | 0.5 | 99.5 |
| | 0.7 | 0.7 | 99.3 |
| | 0.9 | 0.9 | 99.1 |

Samples of each of the compositions in Table 2 are analyzed (in triplicate) using a Hunter Colorquest XE (Hunter Associates Laboratory, Inc., Reston, Va.) in the dry and hydrated form. Samples are hydrated by dissolving 0.493 g (approximately 1 teaspoon) of the composition in 236.58 g (approximately 8 ounces) of distilled water.

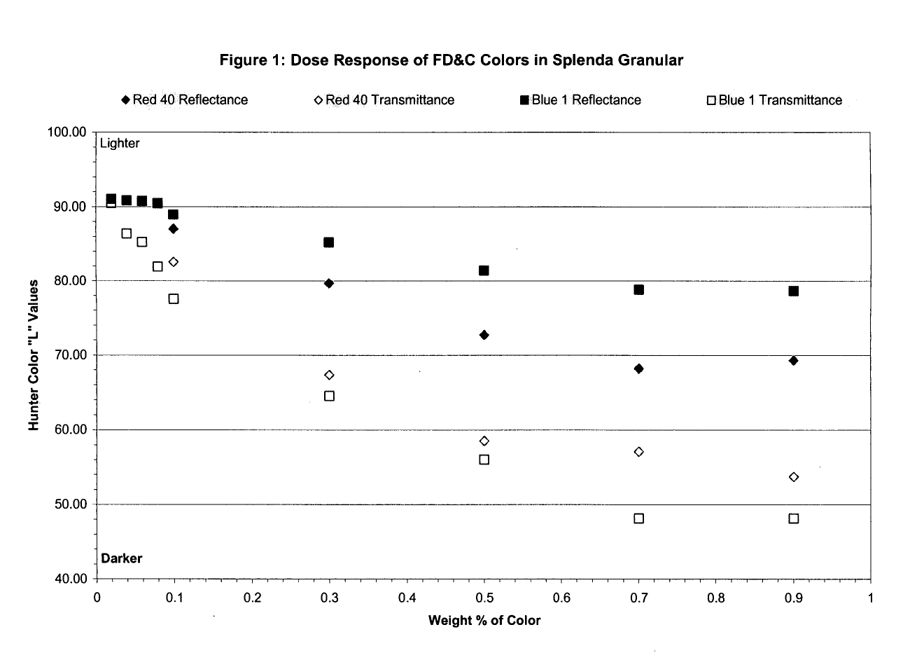

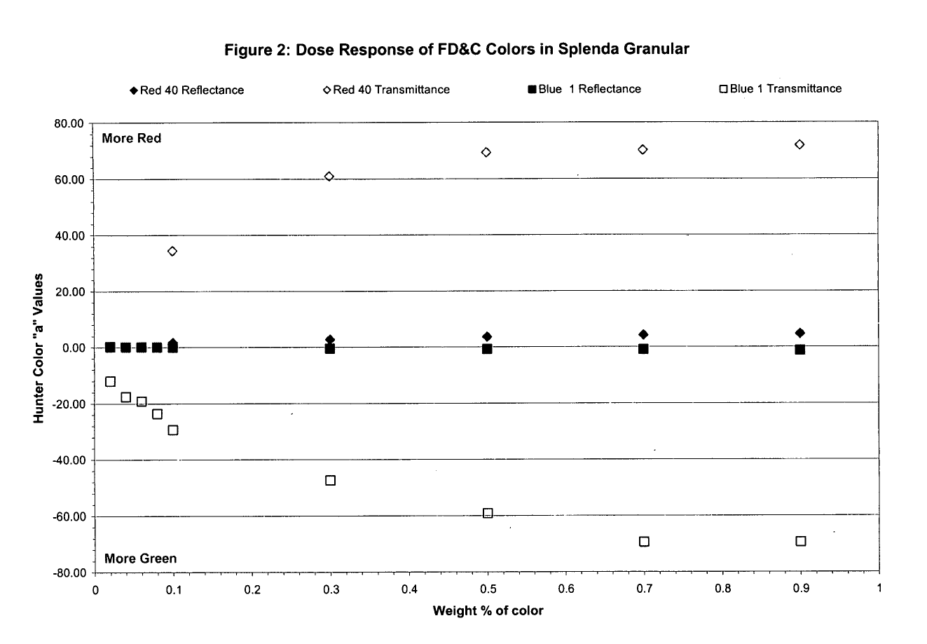

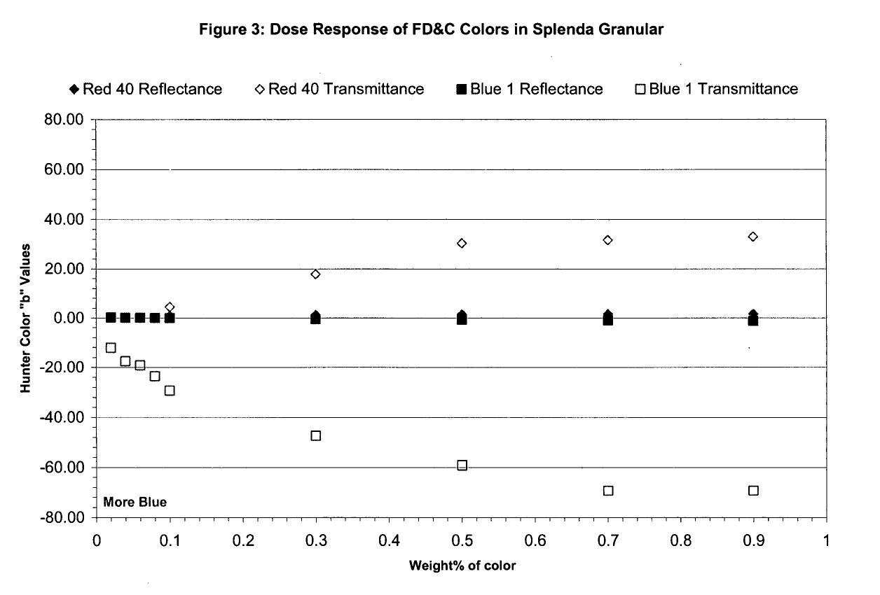

Although not visually noticeable at the lowest dosage levels, the Hunter Color L, a, and b values of the dry samples are lower than the typical L, a, and b values for granular sucrose, 92.72, −0.12, and 0.58, respectively. (Wisconsin-Staley Control, Time 0.) (data not shown.) The dose responses of the compositions are shown in FIGS. 1-3 and Table 3, below. The color changes plateaued at concentrations greater than 0.7%. Visually, the colors of these hydrated samples are quite vivid and noticeably different in the dry form.

TABLE 3
Dose response of hydrated sucralose and
FD&C Red No. 40 or FD&C Blue No. 1.

| | Weight | Reflectance | | | Transmittance | | |
|---|---|---|---|---|---|---|---|
| Coloring Agent | (%) | L | A | b | L | a | b |
| Red No. 40 | 0.1 | 87.04 | 1.64 | 0.96 | 82.54 | 34.50 | 4.46 |
| | 0.3 | 79.66 | 2.70 | 1.21 | 67.32 | 60.99 | 17.80 |
| | 0.5 | 72.69 | 3.61 | 1.40 | 58.52 | 69.41 | 30.42 |
| | 0.7 | 68.18 | 4.22 | 1.58 | 57.12 | 70.12 | 31.71 |
| | 0.9 | 69.30 | 4.59 | 1.65 | 53.73 | 71.84 | 33.03 |
| Blue No. 1 | 0.02 | 91.05 | 0.06 | 0.17 | 90.48 | −18.64 | −12.09 |
| | 0.04 | 90.82 | 0.10 | 0.08 | 86.40 | −24.96 | −17.57 |
| | 0.06 | 90.77 | 0.08 | 0.03 | 85.23 | −26.55 | −19.15 |
| | 0.08 | 90.48 | 0.05 | −0.03 | 81.91 | −30.38 | −23.61 |
| | 0.1 | 88.94 | 0.20 | −0.05 | 77.52 | −33.71 | −29.34 |
| | 0.3 | 85.23 | 0.25 | −0.59 | 64.52 | −35.61 | −47.41 |
| | 0.5 | 81.40 | 0.54 | −0.78 | 56.02 | −30.28 | −59.18 |
| | 0.7 | 78.80 | 0.37 | −1.03 | 48.15 | −22.06 | −69.36 |
| | 0.9 | 78.65 | 0.31 | −1.28 | 48.15 | −22.05 | −69.38 |

### Example 2

Compositions of the present invention with the amounts of SPLENDA® Brand No Calorie Sweetener and coloring agent shown in Table 4 are prepared in two quart mason jars by mixing for 5 minutes at 32 rpm using a Turbula T2F dry powders mixer.

TABLE 4
SPLENDA ® Brand No Calorie Sweetener and
FD&C Yellow No. 5 and Green No. 3 compositions.

| | | Weight (g) | |
|---|---|---|---|
| | | | SPLENDA ® |
| | | | Brand No |
| Coloring | | | Calorie |
| Agent | Weight (%) | Coloring Agent | Sweetener |
| Yellow No. 5 | 0.01 | 0.01 | 99.99 |
| | 0.02 | 0.02 | 99.98 |
| | 0.04 | 0.04 | 99.96 |
| | 0.06 | 0.06 | 99.94 |
| | 0.08 | 0.08 | 99.92 |
| | 0.1 | 0.1 | 99.9 |
| | 0.3 | 0.3 | 99.7 |
| | 0.5 | 0.5 | 99.5 |
| | 0.7 | 0.7 | 99.3 |
| | 0.9 | 0.9 | 99.1 |
| | 1.0 | 1.0 | 99 |
| Green No. 3 | 0.01 | 0.01 | 99.99 |
| | 0.02 | 0.02 | 99.98 |
| | 0.04 | 0.04 | 99.96 |
| | 0.06 | 0.06 | 99.94 |
| | 0.08 | 0.08 | 99.92 |
| | 0.1 | 0.1 | 99.9 |
| | 0.3 | 0.3 | 99.7 |
| | 0.5 | 0.5 | 99.5 |
| | 0.7 | 0.7 | 99.3 |
| | 0.9 | 0.9 | 99.1 |
| | 1.0 | 1.0 | 99 |

Samples of each of the compositions in Table 4 are analyzed (in triplicate) using a Hunter Colorquest XE in the dry and hydrated form. Samples are hydrated by dissolving 0.493 g (approximately 1 teaspoon) of the composition in 236.58 g (approximately 8 ounces) of distilled water.

The dose responses of the compositions are shown in Table 5, below.

TABLE 5
Dose response of hydrated sucralose and
FD&C Yellow No. 5 or FD&C Green No. 3.

| | Weight | Reflectance | | | Transmittance | | |
|---|---|---|---|---|---|---|---|
| Coloring Agent | (%) | L | A | b | L | a | b |
| Yellow No. 5 | 0.01 | 92.62 | 0.07 | 0.67 | 99.88 | −0.70 | 1.87 |
| | 0.02 | 91.86 | 0.43 | 1.08 | 99.68 | −1.86 | 4.94 |
| | 0.04 | 90.68 | 0.96 | 1.57 | 99.45 | −2.96 | 7.92 |
| | 0.06 | 91.13 | 1.15 | 1.83 | 98.92 | −6.27 | 17.11 |
| | 0.08 | 91.26 | 0.99 | 1.69 | 98.97 | −6.24 | 16.96 |
| | 0.1 | 90.61 | 2.10 | 2.63 | 98.37 | −9.38 | 26.33 |
| | 0.3 | 87.79 | 5.29 | 5.51 | 95.98 | −15.44 | 51.24 |
| | 0.5 | 84.17 | 7.74 | 8.26 | 94.85 | −14.53 | 56.57 |
| | 0.7 | 80.54 | 9.20 | 7.80 | 94.26 | −13.35 | 57.99 |
| | 0.9 | 78.31 | 15.41 | 11.52 | 93.31 | −10.81 | 58.94 |
| | 1.0 | 79.49 | 13.42 | 10.55 | 92.88 | −9.52 | 59.02 |
| Green No. 3 | 0.01 | 93.22 | −0.11 | 0.47 | — | — | — |
| | 0.02 | 92.79 | 0.23 | 0.63 | — | — | — |
| | 0.04 | 92.51 | 0.48 | 0.76 | — | — | — |
| | 0.06 | 91.40 | 0.84 | 0.90 | — | — | — |
| | 0.08 | 89.85 | 1.26 | 1.05 | — | — | — |
| | 0.1 | 90.69 | 1.37 | 1.10 | — | — | — |
| | 0.3 | 85.03 | 3.49 | 1.91 | — | — | — |
| | 0.5 | 82.75 | 4.66 | 2.35 | — | — | — |
| | 0.7 | 75.55 | 7.59 | 3.38 | — | — | — |
| | 0.9 | 73.34 | 7.94 | 3.46 | — | — | — |
| | 1.0 | 76.25 | 7.67 | 3.53 | — | — | — |

### Example 3

Compositions of the present invention with the amounts of SPLENDA® Brand No Calorie Sweetener and two coloring agents as shown in Table 6 are prepared in two quart mason jars by mixing for 5 minutes at 32 rpm using a Turbula T2F dry powders mixer.

TABLE 6
SPLENDA ® Brand No Calorie Sweetener and
FD&C Yellow No. 5 and Green No. 3 compositions.

| | Weight (g) | | |
|---|---|---|---|
| | | | SPLENDA ® |
| Total Weight | | | Brand No |
| of Coloring | | | Calorie |
| Agents (%) | Yellow No. 6 | Green No. 3 | Sweetener |
| 0.06 | 0.05 | 0.01 | 99.94 |
| 0.08 | 0.067 | 0.013 | 99.92 |
| 0.1 | 0.083 | 0.017 | 99.9 |
| 0.3 | 0.2583 | 0.0499 | 99.7 |
| 0.7 | 0.5829 | 0.1169 | 99.3 |
| 0.9 | 0.7503 | 0.1501 | 99.1 |
| 1.0 | 0.833 | 0.1675 | 99 |
| 1.24 | 0.4172 | 0.831 | 99.5 |

Samples of each of the compositions in Table 6 are analyzed (in triplicate) using a Hunter Colorquest XE in the dry and hydrated form. Samples are hydrated by dissolving 0.493 g (approximately 1 teaspoon) of the composition in 236.58 g (approximately 8 ounces) of distilled water.

The dose responses of this composition are shown in Table 7, below.

TABLE 7
Dose response of hydrated sucralose,
FD&C Yellow No. 6, and Green No. 3.

| Total Weight of | | | | | | |
|---|---|---|---|---|---|---|
| Coloring | Reflectance | | | Transmittance | | |
| Agents (%) | L | a | b | L | a | b |
| 0.06 | — | — | — | 92.78 | −1.39 | 6.38 |
| 0.08 | — | — | — | 93.02 | −0.58 | 6.92 |
| 0.1 | — | — | — | 87.70 | −1.52 | 11.81 |
| 0.3 | — | — | — | 62.22 | 0.16 | 28.97 |
| 0.7 | — | — | — | 41.77 | −5.83 | 23.51 |
| 0.9 | — | — | — | 51.94 | −9.05 | 30.19 |
| 1.0 | — | — | — | 34.77 | −10.41 | 22.71 |
| 1.24 | — | — | — | 54.86 | −4.09 | 26.26 |

### Example 4

Compositions of the present invention are made containing the quantity of sucrose and coloring agents shown in Table 8. The compositions are prepared in two quart mason jars by mixing for 5 minutes at 32 rpm using a Turbula T2F dry powders mixer.

TABLE 8
SPLENDA ® Brand No Calorie Sweetener
and coloring agent compositions.

| | | | | SPLENDA ® |
|---|---|---|---|---|
| | Coloring Agent (Weight %) | | | Brand No |
| | FD&C | FD&C | FD&C | Calorie |
| Color in | Red | Blue | Yellow | Sweetener |
| Milk | No. 40 | No. 1 | No. 5 | (Weight %) |
| Red | 0.9 | — | — | 99.1 |
| Blue | — | 0.3 | — | 99.7 |
| Purple | 0.6 | 0.1 | — | 99.3 |
| Yellow | — | — | 0.9 | 99.1 |
| Green | — | 0.15 | 0.45 | 99.4 |
| Orange | 0.36 | — | 0.54 | 99.1 |

Each of these compositions results in a strong, visibly detectible color change when 0.493 g (approximately 1 teaspoon) of the composition is dissolved in 240 milliliters (approximately 8 ounces) of fat-free milk.

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalents.

What is claimed is:

1. A composition comprising a high intensity sweetener and a coloring agent.

2. A composition according to claim 1, wherein the high intensity sweetener is selected from the group consisting of a sugar alcohol, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucrose, stevia, thaumatin, salts, derivatives, and combinations thereof.

3. A composition according to claim 2, wherein the high intensity sweetener is sucrralose.

4. A composition according to claim 1, wherein the coloring agent is a food-grade dye or lake.

5. A composition according to claim 1, wherein the coloring agent is selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice, beet powder, beta-carotene, beta-apo-8-carotenal, black currant, burnt sugar, canthaxanthin, caramel, carbo medicinalis, carmine, carmine/beta-carotene, carmine blue, carminic acid, carrot, carrot oils, chlorophyll, chlorophyllin, cochineal extract, copper-chlorophyll, copper-chlorophyllin, curcumin, curcumin/Cu-chlorophyllin, elderberry, grape, grape skin extracts, hibiscus, lutein, mixed carotenoids, paprika, paprika extract, paprika oleoresin, riboflavin, saffron, spinach, stinging nettle, titanium dioxide, turmeric, and combinations thereof.

6. A composition according to claim 5, wherein the coloring agent is selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

7. A composition according to claim 1, further comprising at least one additional coloring agent.

8. A composition according to claim 1, further comprising a food-grade additive selected from the group consisting of carbonation systems, flavors, texture enhancers, aromas, bulking agents, and combinations thereof.

9. A composition according to claim 8, wherein the additive is a carbonation system.

10. A composition according to claim 1, wherein the coloring agent is enrobed in the high intensity sweetener itself or in a composition comprising the high intensity sweetener.

11. A composition according to claim 1, wherein the high intensity sweetener is encased by a shell comprising an encapsulating agent and the coloring agent.

12. A composition according to claim 1, wherein the high intensity sweetener and coloring agent are encased by a shell comprising an encapsulating agent.

13. A composition according to claim 1, wherein the coloring agent is macro-encapsulated or micro-encapsulated in an encapsulating agent.

14. A composition according to claim 7, wherein at least one of the coloring agents is macro-encapsulated or micro-encapsulated in an encapsulating agent.

15. A composition according to claim 14, wherein the high intensity sweetener and coloring agents are further encased by a shell comprising an encapsulating agent.

16. A composition according to claim 14, wherein each coloring agent is separately encapsulated in the same encapsulating agent.

17. A composition according to claim 16, wherein the high intensity sweetener and coloring agents are further encased by a shell comprising an encapsulating agent.

18. A composition according to claim 14, wherein a plurality of coloring agents are encapsulated in a plurality of different encapsulating agents.

19. A composition according to claim 1, wherein the composition is in a form selected from the group consisting of liquids, granules, tablets, powders, crystals, and cubes.

20. A composition according to claim 1, wherein the composition is incorporated into a breath strip or a mint.

21. A composition according to claim 1, wherein the composition is in intimate contact with a device for contacting a foodstuff.

22. A composition according to claim 21, wherein the composition is incorporated into an interior compartment of the device.

23. A composition according to claim 22, wherein the device is a swizzle stick, stirrer, or straw.

24. A composition according to claim 21, wherein the composition is disposed on a surface of the device.

25. A composition according to claim 24, wherein the device is a swizzle stick or stirrer.

26. A composition comprising sucrose and a coloring agent selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

27. A foodstuff comprising a composition according to claim 1.

28. A foodstuff according to claim 27, wherein the foodstuff is a liquid.

29. A foodstuff according to claim 27, wherein the foodstuff is a dry formulation.

30. A method of making a composition for sweetening and coloring a foodstuff comprising combining a high intensity sweetener and a coloring agent.

31. A method according to claim 30, further comprising enrobing the coloring agent in the high intensity sweetener itself or in a composition comprising the high intensity sweetener.

32. A method according to claim 30, further comprising encasing the high intensity sweetener in a shell comprising an encapsulating agent and the coloring agent.

33. A method according to claim 30, further comprising macro-encapsulating or micro-encapsulating the coloring agent in an encapsulating agent.

34. A method according to claim 30, wherein the composition further comprises at least one additional coloring agent.

35. A method according to claim 34, further comprising macro-encapsulating or micro-encapsulating at least one of the coloring agents in an encapsulating agent.

36. A composition according to claim 34, further comprising separately encapsulating each coloring agent in the same encapsulating agent.

37. A composition according to claim 34, further comprising encapsulating a plurality of coloring agents in a plurality of different encapsulating agents.

38. A method for preparing a foodstuff comprising combining a foodstuff with a composition comprising a high intensity sweetener and a coloring agent.
